(19) United States
(12) Patent Application Publication
(10) Pub. No.: US 2018/0113500 A1
(43) Pub. Date: Apr. 26, 2018

(54) SYSTEMS AND METHODS FOR MONITORING BATTERY LIFE

(71) Applicant: Wandering WiFi LLC, Atlanta, GA (US)

(72) Inventors: Joseph Loeffler, Lilburn, GA (US); Dawei Cai, Atlanta, GA (US); Jyothiprakash Halebeed, Marietta, GA (US)

(21) Appl. No.: 15/792,157

(22) Filed: Oct. 24, 2017

Related U.S. Application Data
(60) Provisional application No. 62/411,826, filed on Oct. 24, 2016.

(51) Int. Cl. G06F 1/32; G06F 11/32; G06F 11/34

(52) U.S. Cl. CPC G06F 1/3212; G06F 11/3476; G06F 11/3442; G06F 11/327

(57) ABSTRACT

A system can include a battery, a processing device, and a memory device. The battery can power a device. The memory device can store instructions are stored for causing the processing device to track data about the battery. The processing device can determine a battery life of the battery based on the data. The battery life can indicate a degradation in the battery over multiple discharge cycles. The processing device can notify a user of the device if the battery life is below a threshold value.

### CROSS REFERENCE TO RELATED APPLICATIONS

This disclosure claims the benefit of priority of U.S. provisional Application No. 62/411,826 titled “Systems and Methods for Monitoring Battery Life” and filed on Oct. 24, 2016, which is hereby incorporated in its entirety by this reference.

### TECHNICAL FIELD

This disclosure generally relates to batteries and more particularly, although not necessarily exclusively, to systems and methods for monitoring battery life.

### BACKGROUND

A battery can store chemical energy, which can be converted into electrical energy to provide a device (e.g., a mobile phone or a mobile scanner) with electrical power. The chemical energy can be depleted as the electrical energy is discharged. A rechargeable battery can be recharged by applying an electric current to the battery to reverse a chemical reaction that occurred during discharge. Certain rechargeable batteries can be discharged and recharged multiple times.

As a rechargeable battery degrades, the battery life of the rechargeable battery is reduced. A rechargeable battery can degrade to a state in which the battery life of the rechargeable battery is too short to complete some operations with a device and the battery can be referred to as “dead.”

### SUMMARY

Aspects and examples are disclosed for monitoring battery life. In some aspects, a system, which can include a battery, a processing device, and a memory device. The battery can power a device. The processing device can track data about the battery and determine a battery life of the battery based on the data. The battery life can indicate a degradation in the battery over multiple discharge cycles. The processing device can also notify a user of the device if the processing device determines that the battery life is below a threshold value.

This illustrative example is mentioned not to limit or define the inventions, but to aid understanding thereof. Other aspects, advantages, and features of the present invention will become apparent after review of the entire description and figures.

### BRIEF DESCRIPTION OF THE DRAWINGS

Many aspects of the present disclosure can be better understood with reference to the following diagrams. The drawings are not necessarily to scale, with emphasis instead being placed upon clearly illustrating certain features of the disclosure.

FIG. 1 is a block diagram of a system for monitoring battery life according to one aspect of the present disclosure.

FIG. 2 is a block diagram of a smart battery for monitoring battery life according to one aspect of the present disclosure.

FIG. 3 is a flow chart of a process for monitoring battery life according to one aspect of the present disclosure.

FIG. 4 is a block diagram of examples of devices in a system for monitoring battery life according to one aspect of the present disclosure.

### DETAILED DESCRIPTION

Computer-implemented systems and methods are disclosed for monitoring battery life. The phrase “battery life” can refer to a length of time that a fully charged battery can provide electrical energy to a device before the battery is depleted. The battery life can indicate a degradation in the battery over multiple discharge cycles. For example, a first battery having a certain battery type and a longer battery life may maintain a charge for eight hours, and a second battery having the same battery type and a shorter battery life may maintain a charge for four hours. Monitoring a battery life may include, in some aspects, tracking multiple facets of the components of the battery (e.g., how many times the battery has been charged, when the battery was actually manufactured, actual degradation of the charge cycle for the battery, etc.). The monitored data can be used to determine if the battery is toward the end of its battery life, and therefore should not be used. For example, if a determined battery life indicates that a given battery, which is intended to be used for eight hours continuously (e.g., in a warehouse or shipping context), will only last four hours, a notification can be provided to a user indicating that the battery should not be used. A server can track the notifications and provide a report of each batteries' ability to be used for its intended use based on the battery's battery life.

In some aspects, a system can monitor battery life of a battery by tracking and recording data about the battery. One example of a system that monitors battery life is a smart battery, which includes an energy storage element and processing circuitry for recording and processing data related to the battery life. Another example of a system that monitors battery life is a device that receives a battery (e.g., a battery other than a smart battery) having an energy storage element. The device can also include processing circuitry that may be used for recording and processing data related to the battery life or for enabling the recording and processing of data related to battery life. In these systems, the recorded battery data can include a manufacturing date of the battery, a number of charge cycles performed by the battery, a number of discharge cycles performed by the battery, a charging rate of the battery, a discharging rate of the battery, and environmental conditions of the battery.

A battery-monitoring system can include a processing device that can analyze the data to determine the battery life of the battery. In some aspects, the system can display to the user the battery life of the battery. In additional or alternative aspects, the system can prevent the user from using a battery with a battery life below a threshold value.

A battery life below a threshold level can indicate that the battery life of the battery is insufficient for powering a device long enough to complete a task. In some aspects, the battery can be determined to be dead (e.g., unusable or in need or a replacement) if the battery life is below the threshold level. In additional or alternative aspects, a battery can be determined to be dead based on the battery being older than a predetermined value (e.g., 18 months) or based on the battery having performed more than a predetermined number of charge cycles (e.g., 550 charging cycles). In some aspects, a system can track and record data about more than one battery. The batteries can be of a similar type (e.g., made by the same manufacturer or used to power similar devices) or may be different. The system can use the data about the batteries to generate a model for determining whether a battery life of a particular type of battery is below a threshold level.

In some aspects, the system can notify a user that the battery life of the battery is insufficient for completing a task. In some aspects, notifying the user can include displaying data to the user based on the battery life of the battery. In additional or alternative aspects, notifying the user can include preventing the user from using the battery based on the battery life being insufficient for completing the task. The efficiency of completing the task can be improved by preventing the use of a certain battery if using that battery would require, for example, the user to stop to recharge or replace the battery during performance of the task.

In some aspects, the battery may be used for powering a device that requires authorization with a server in the network to perform some operations. The server may determine that the battery life is sufficient for completing the operation before providing authorization to use the battery. These aspects may involve smart batteries (e.g., devices in which energy storage elements and processing logic are integrated in the same device) or non-smart batteries (e.g., systems in which energy storage elements are not integrated with devices that include processing logic for monitoring the battery). In additional or alternative aspects, the battery can be a smart battery that determines whether a battery life of the smart battery is below a threshold value, and, if so, that prevents discharge of electricity to a device and/or provides a notification of the low battery life to a user (e.g., by providing sufficient power to the device to output the notification, but insufficient power for performing other device features).

As used herein, the term “mobile device” can include a computing device capable of establishing wireless connections at multiple geographic locations. Examples of a mobile device include (but are not limited to) a laptop, a tablet, a portable scanner having processing circuitry, an Internet-of-things device, etc.

As used herein, the term “connect” can include establishing a communication channel between a mobile device and a wireless local area network (“WLAN”) via which the mobile device can access other network devices or other data networks via the WLAN. A connection to a WLAN can be established via any suitable wired or wireless method. A connection to a WLAN uses any suitable protocol, such as (but not limited to) Wi-Fi.

As used herein, the term “authorized” can refer to a user having permission to use a device based on the user's identity, subscription, or other terms or conditions imposed upon the use of the mobile device. In some aspects, software can be executed locally on a device to authenticate a user or otherwise determine that a user is authorized to use the device. In additional or alternative aspects, a device can transmit credentials (e.g., a user name and password or some other identification data), which can be received from a user, to a remote server that executes the software for authenticating or otherwise determining that the user is authorized to use the device.

The foregoing illustrative examples are given to introduce the general subject matter discussed herein and are not intended to limit the scope of the disclosed concepts. The following sections describe various additional aspects and examples with reference to the drawings in which like numerals indicate like elements. The features discussed herein are not limited to any particular hardware architecture and/or configuration. A computing device can include any suitable arrangement of components that provide a result conditioned on at least one input. Suitable computing devices include multipurpose microprocessor-based computer systems accessing stored software that programs and/or configures the computing system from a general-purpose computing apparatus to a specialized computing apparatus implementing one or more aspects of the present subject matter. Any suitable programming, scripting, and/or other type of language and/or combinations of languages may be used to implement the teachings contained herein in software to be used in programming and/or configuring a computing device. Aspects and features from each embodiment disclosed can be combined with any other embodiment.

### Example of an Operating Environment for Monitoring Battery Life

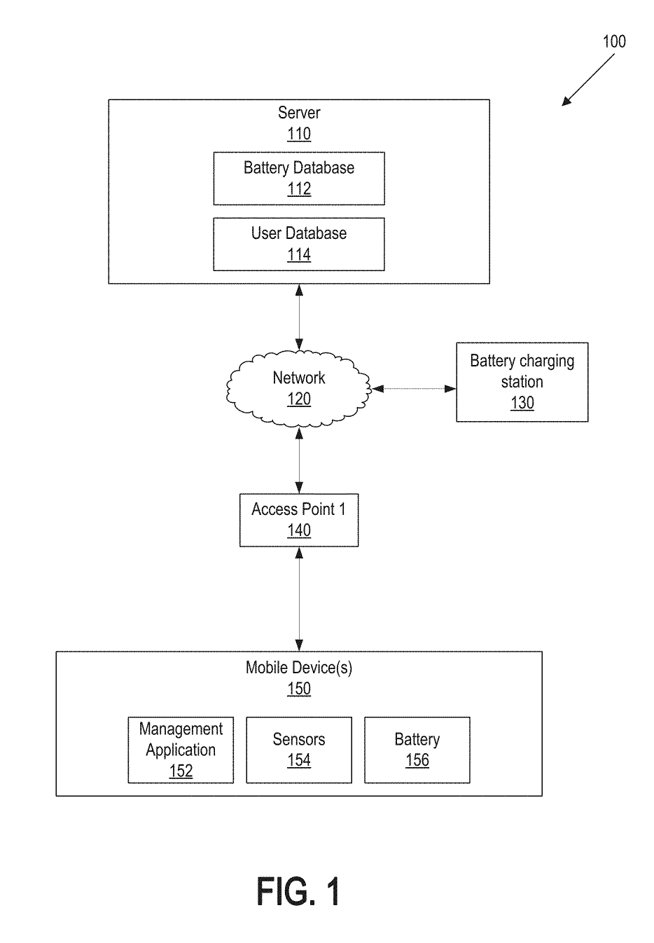

FIG. 1 depicts an example of system 100 for monitoring battery life. The system 100 can include a mobile device 150 and a server 110 connected via a network 120. In some aspects, the system 100 can include a battery charging station 130 connected to the server 110 via the network 120. In some aspects, the mobile device 150 can be wirelessly connected to an access point 140 for gaining access to the network 120. In additional or alternative aspects, the mobile device 150 can be connected to the network 120 by a wireline. The mobile device 150 can include a management application 152, sensors 154, and a battery 156. The server 110 can include a user database 114 and a battery database 112. To use the mobile device 150, a user can be verified by the server 110. For example, a user can input a username and password into the mobile device 150, and the mobile device 150 can transmit the username and password to the server 110. The server 110 can compare the username and password to information stored in the user database 114 and transmit a signal to the mobile device 150 indicating that the user is authorized to use the mobile device 150. The mobile device 150 or the server 110 can record usage of the mobile device 150 by the user in the user database 114.

The battery database 112 can include information about the battery 156 The battery 156 can include a serial number or another unique identifier such that the battery 156 can be tracked across multiple mobile devices 150. Sensors 154 in the mobile device 150, the battery 156, or both can track the discharge rate of the battery 156 or environmental conditions of the battery 156 and transmit data about the battery 156 for storage in the battery database 112. In some aspects, the environmental conditions (e.g., temperature and humidity) experienced by the battery 156 can be determined based on measurements from various sensors. For example, the environmental conditions can be determined based on measurements from sensors located throughout a storage area or at the battery charging station 130. In additional or alternative aspects, device settings (e.g., screen brightness, hibernation timing, and speaker volume) can be tracked and recorded. The device settings can be used to determine a load experienced by the battery 156. Data about the battery 156 (e.g., number of charging cycles, the charging rate of the battery 156 at the battery charging station 130, one or more environmental conditions, historical data about one or more device settings, etc.) can be monitored and recorded in the battery database 112. Additional data can be determined about the battery 156 (e.g., battery chemistry, the number of battery cells, an expected voltage, and an expected amp hour) and recorded in the battery database 112. In some aspects, data about the battery 156 can be received from a user of a mobile device 150 in which the battery 156 is installed. In additional or alternative aspects, data about the battery 156 can be obtained via communication with a computing system associated with a manufacturer of the battery 156 (e.g., by accessing a website or other data system provided by the manufacturer.) In additional or alternative aspects, data about the battery 156 can be determined by accessing stored data (e.g., research data stored in a database) that is accessible to the system 100 that monitors battery data and determines a battery life.

In some aspects, the server 110 can track and record data about more than one battery in the battery database 112. The server 110 can group the batteries. For example, the server 110 can group the batteries based on one or more of manufacturer, model, use with certain mobile devices 150, or use by particular users. The server 110 can generate models based on data recorded about different groups of batteries for estimating or otherwise determining when a battery life of a particular battery 156 will be below a threshold value.

In some aspects, the server 110 can include a display for reporting information about the batteries to a user. The display can include a user interface for reporting the estimated time left (life span) of each battery 156 in the battery database 112. The server 110 can analyze the inventory of batteries and provide recommendations to replace batteries based on the analysis. The inventory can be grouped based on battery type (e.g., make or model). The groups can be analyzed to determine performance information (e.g., the number of tasks a battery 156 is used to complete before the battery life of the battery 156 is below the threshold value). In some aspects, the performance information for different groups can be compared to determine a type of battery that best performs (e.g., maintains a battery life above the threshold longer) a specific task. In some aspects, the performance information can be anonymized (e.g., stripped of information related to a specific user) and stored in a centralized database. A server 110 can analyze the performance information of batteries used by various users and display analytics for various batteries. The analytics can be observed by a customer and influence subsequent purchases.

Although FIG. 1 depicts the system with the battery powering the mobile device, a system can monitor a battery life of a battery powering any device. In some aspects, the device may not be connected to a network or a server. The device can include a battery database or a user database and the device can track and record data about the user or the battery. In additional or alternative aspects, the device can determine that the battery life of the battery is below a threshold value and prevent a user from using the device. In some aspects, the battery charging station can include a non-transitory computer-readable medium in which a battery database is stored.

### Examples of Battery Monitoring Devices and Methods

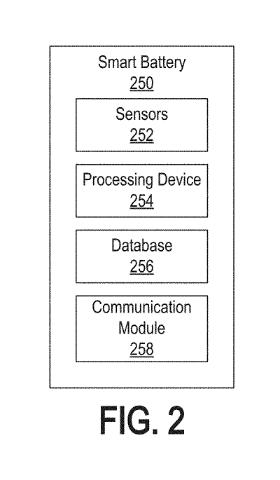

FIG. 2 depicts an example of a smart battery 250 that can monitor a battery life of the smart battery 250. In some examples, the smart battery 250 is an example of the battery 156 in FIG. 1. The smart battery 250 can include sensors 252, a processing device 254, a database 256, and a communication module 258. The smart battery can be used with any device, including a mobile device. In some aspects, the sensors can measure environmental conditions (e.g., temperature) of the smart battery 250. In additional or alternative aspects, the sensors 252 can detect the status of the smart battery 250 (e.g., charging or discharging). In some aspects, the data measured by the sensors 252 an be recorded in the database 256. The processing device 254 can analyze the data in the database 256 to determine the battery life of the smart battery 250.

Over time, the smart battery 250 can degrade, thereby reducing the battery life of the smart battery 250. The processing device 254 can determine the battery life of the smart battery 250 based on an estimated amount that the smart battery 250 has degraded.

The processing device 254 can also determine an amount of time or number of charge cycles that can be performed by the smart battery 250 before the battery life of the smart battery 250 is below a threshold value. The threshold value can be predetermined and stored in the database 256. In some aspects, a predetermined number of charging cycles (e.g., 550) or a predetermined amount of time after the manufacturing date (e.g. 18 months) can be stored in the database 256. The processing device 254 can compare the recorded data with the predetermined data to determine if the smart battery 250 is usable.

In some aspects, the communication module 258 can communicate with a server, a mobile device, other smart batteries, or a charging station. The communication module 258 can receive or transmit data about the smart battery 250. In some aspects, the communication module 258 can transmit the battery life of the smart battery 250 to a mobile device for allowing the mobile device to determine if the battery life is above a threshold value for operating the mobile device.

In some aspects, the processing device 254 can determine performance information for a smart battery 250 or other battery (e.g., a non-smart battery monitored by a processing device) based on recording the number and type of tasks completed while using the smart battery 250 or other battery. The performance information can be analyzed along with data about the number of charging cycles, the number of discharge cycles, environmental conditions, and device settings experienced by the smart battery 250 or other battery to determine a performance rating of the smart battery 250 or other battery. In some aspects, performance ratings for more than one smart battery 250 or other battery can be analyzed to determine conditions for improving battery performance. In additional or alternative aspects, performance ratings for more than one smart battery 250 or other battery can be analyzed to determine the types (e.g., make or model) of smart batteries 250 or other batteries that provide the best performance.

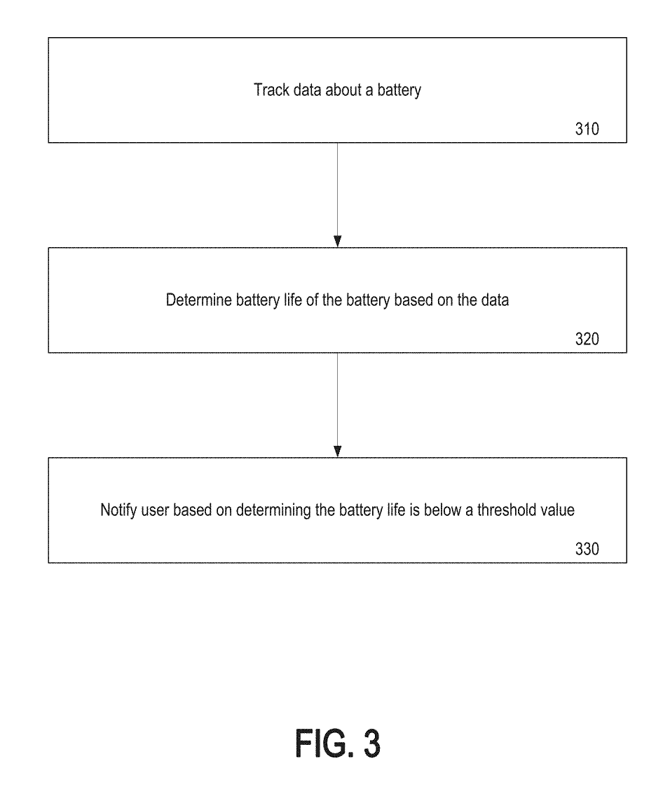

FIG. 3 is a flow chart depicting an example of a process for monitoring battery life. For illustrative purposes, this process is described with respect to the examples depicted in FIGS. 1 and 2. But, other implementations are possible.

In block 310, the process can include tracking data about a battery in a mobile device. The data can include a manufacturing date of the battery, a number of charge cycles performed by the battery, a number of discharge cycles performed by the battery, a charging rate of the battery, a discharging rate of the battery, and environmental conditions of the battery. The process can include obtaining data from a sensor positioned in the mobile device, in the environment of the mobile device, or at in a charging station for tracking the data. The process can further include recording the data in a database.

In block 320, the process can further include analyzing the data to determine the battery life of the battery. In some aspects, a processing device can be included in the mobile device for analyzing the data. In additional or alternative aspects, the processing device can be included in the server or another device connected to the mobile device.

In block 330, The process can further include notifying the user based on determining that the battery life is below a threshold value. In some aspects, the threshold value can be a predetermined value. For example, the threshold value can be predetermined to be eight hours such that the battery can provide power during an 8-hour shift. In additional or alternative aspects, the threshold value can be determined based on input from the user, based on the device being powered, and/or based on the task being performed. For example, a system can track the time and power it takes a user to complete a task and record the information as historical data for the user to complete the task. The system can respond to the user, from which a request to use the battery to complete the task is received, by comparing the battery life of the battery to a threshold value based on the historical data recorded by the user for completing the task.

In this example, using historical data about a battery to calculate the amount of time the battery will last can allow a worker or other user of the battery to determine whether the battery will last throughout a shift (e.g., by notifying the user that a battery has insufficient life to last through a specified time period, such as a work shift). This insufficient like can include a partially charged battery being used or a battery that is approaching the end of its life being used. A server or other computing system that monitors the battery can transmit a notification to a device associated with the user. The server can also track battery-related events for reporting purposes.

Setting the threshold value above the time it takes for the user to complete a given task can improve efficiency by notifying the user if the battery will be depleted during completion of the task. In some aspects, notifying the user can include displaying a message to user indicating the battery life of the battery. In additional or alternative aspects, notifying the user can include preventing the user from using the battery to power the device.

In some aspects, a battery can power a portable scanner that can be used for inventorying products in a warehouse. The warehouse can include multiple portable scanners that can be shared between multiple users. In one example, any user can pick up a portable scanner and use the portable scanner. The portable scanners can be connected to a network, and a user may log in to the network using the portable scanner to gain access to some functionalities of the portable scanner. Data about the user, the use of the portable scanner, and the battery can be tracked and recorded by a server connected to the network. For example, data about the access point to which the portable scanner is connected may be recorded. The recorded data can be used to determine a time and a location in the warehouse the portable scanner was used. Data about the use of the portable scanner can also be used to determine data about the use of the battery powering the portable scanner. The server can also track and record the discharge rate of the battery. In some aspects, a charging station for the battery can be connected to the network and data based on the charging rate of the battery and the number of charging cycles of the battery can be tracked and recorded.

In additional or alternative aspects, the battery life of a battery can be below a threshold level. The threshold level can be determined based on an amount of time for the user to complete a task (e.g., an eight-hour shift or a shipping operation). The server can determine the battery life of the battery is below the threshold value and prevent the user from logging into a device using the battery. Preventing the user from using the battery can prevent downtime during the completion of the task, which can be caused by the user needing to replace or recharge the battery in the portable scanner. Reducing downtime during the task can increase the efficiency and reduce the cost of performing the task.

### Examples of Computing Systems

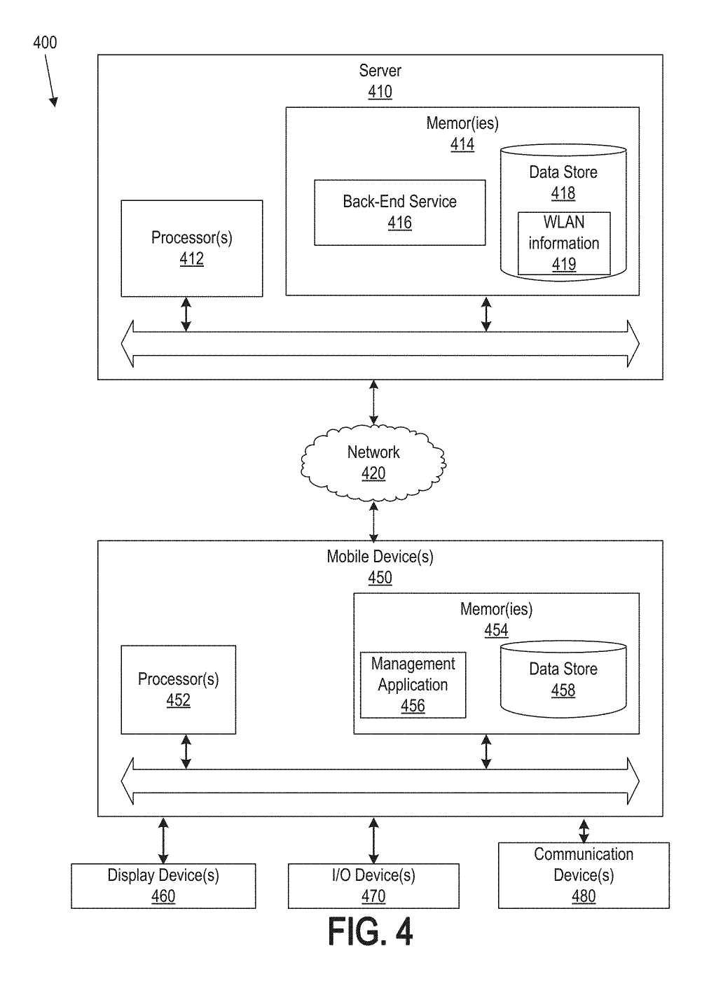

Any suitable device can be used to implement the embodiments described herein. For example, FIG. 4 is a block diagram depicting examples of computing devices 400 for implementing certain embodiments. The computing devices 400 can include a server 410 and at least one mobile device 450 in communication via a network 420. A general discussion of the components of the server 410 and the mobile device 450 is provided below.

The server 410 may include at least one server computer or any other system providing capabilities for managing access to resources and/or distributing resources to mobile devices. In some embodiments, multiple servers may be employed that are configured in at least one server bank, computer banks, or other arrangements. For example, multiple servers may be configured to provide a cloud computing resource, a grid computing resource, and/or any other distributed computing arrangement. Such servers may be located in a single installation or may be distributed among many different geographic locations. For purposes of convenience, the server 410 is referred to herein in the singular. Even though the server 410 is referred to in the singular, it is understood that multiple servers may be employed in the arrangements as descried herein.

The mobile device 450 can include any suitable computing device or system for communicating via the network and executing at least one application. Non-limiting examples of a mobile device 450 include a laptop computer, a personal digital assistant, a cellular telephone, a set-top box, a music player, a web pad, a tablet computer system, or another device with similar capability. The mobile device 450 may be configured to execute various applications. For example, the mobile device 450 may be configured to execute applications such as web browsing applications, email applications, instant messaging applications, and/or other applications capable of receiving and/or rendering resources on a display associated with the mobile device 450.

The server 410 and the mobile device 450 can include processors 412, 452. Each of the processors 412, 452 may be a microprocessor, an application-specific integrated circuit (“ASIC”), or other suitable processing device. Each of the processors 412, 452 can include any number of computer processing devices, including one. Each of the processors 412, 452 can be communicatively coupled to a computer-readable medium, such as the memory devices 414, 454. Each of the processors 412, 452 can execute computer-executable program instructions and/or accesses information respectively stored in the memory device 414 of the server 410 and in the memory device 454 device of the mobile device 450.

Each of the memory devices 414, 454 can include a computer-readable medium or other memory device. A computer-readable medium or other memory device can include both volatile and nonvolatile memory and data storage components. Volatile components are those that do not retain data values upon loss of power. Nonvolatile components include memory components that retain data upon a loss of power. A computer-readable medium may include (but is not limited to) an electronic, optical, magnetic, or other storage device capable of providing a processor with computer-readable instructions. Other examples comprise, but are not limited to, magnetic disk or other magnetic storage, memory chip, read-only memory (“ROM”), random access memory (“RAM”), an ASIC, a configured processor, optical storage accessed via an optical medium drive, solid-state drives, USB flash drives, memory cards accessed via a memory card reader, magnetic tapes accessed via an appropriate tape drive, and/or other memory components, or a combination of any two or more of these memory components. RAM may include, for example, static random access memory (“SRAM”), dynamic random access memory (“DRAM”), or magnetic random access memory (“MRAM”) and other such devices. ROM may comprise, for example, a programmable read-only memory (“PROM”), an erasable programmable read-only memory (“EPROM”), an electrically erasable programmable read-only memory (“EEPROM”), or other like memory device.

The processor 412 and the memory device 414 of the server 410 may be communicatively coupled to a local interface. The processor and the memory device of the mobile device may be communicatively coupled to a local interface. A local interface can include, for example, a data bus with an accompanying address/control bus or other bus structure. One or more of the processors 412 may represent multiple processing devices and one or more of the memory devices 414 may represent multiple memory devices that operate in parallel processing circuits, respectively. In such a case, one or more of the local interfaces may include an appropriate network that facilitates communication between any two of the multiple processors or between any two of the multiple memory devices. The local interfaces may comprise additional systems designed to coordinate this communication, including, for example, performing load balancing.

The mobile device 450 may also include a number of external or internal devices such as a mouse, a keyboard, a display, audio speakers, one or more microphones, or any other input or output devices 470. For example, the mobile device may include or be in data communication with a display device 460. A non-limiting example of the display device 460 is a computer screen, such as a touch screen. Although FIG. 4 depicts the display device 460 as a separate device coupled to the mobile device 450, the display device 460 can be integrated into the mobile device 450.

The mobile device 450 can also include one or more communication devices 480. One of the communication devices 480 can include a wired network connectivity component such as, for example, an Ethernet network adapter, a modem, and/or the like. The mobile device 450 may further include a wireless network connectivity interface, for example, a Peripheral Component Interconnect (“PCI”) card, a Universal Serial Bus (“USB”) interface, a Personal Computer Memory Card International Association (“PCMCIA”) card, Secure Digital Input-Output (“SDIO”) card, NewCard, Cardbus, a modem, a wireless radio transceiver, a cellular radio, and/or the like. The mobile device 450 may be operable to communicate via wired connection with the server 410 with the aid of the wired network connectivity component. The mobile device 450 may be further operable to communicate wirelessly with the server 410 with the aid of the wireless network connectivity component.

Instructions stored in the memory device 414 of the server 410 and executable by its processor 412 can include a back-end service 416 and/or other applications. The back-end service 416 can include at least one function for controlling resources executed at computing devices such as the mobile device 450, as described in detail herein. Certain data may be stored in a data store 418 of the memory device 414 that is part of or otherwise accessible to the server 410. In some examples the data store 418 can include WLAN information 419 for communicating with the mobile device 450 via the network 420. The illustrated data store 418 may be representative of a multiple data stores, as can be appreciated.

Instructions stored in the memory device 454 of the mobile device 450 and executable by its processor 452 can include a management application 456. The management application 456 can include at least one function for controlling resources executed at computing devices such as mobile device 450, as described in detail herein. Certain data may be stored in a data store 458 of the memory device 454 that is part of or otherwise accessible to the mobile device 450. The illustrated data store 458 may be representative of multiple data stores. The data stored in the data store 458 may be associated with the operation of certain applications and/or functional entities described herein.

As used herein, the term “computer-executable program instructions” is used to refer to a program file that is in a form that can ultimately be run by a processor. Examples of computer-executable program instructions may be, for example, a compiled program that can be translated into machine code in a format that can be loaded into a random access portion of a memory and executed by a processor, source code that may be expressed in proper format such as object code that can be loaded into a random access portion of a memory and executed by a processor, source code that may be interpreted by another executable program to generate instructions in a random access portion of a memory and executed by a processor, and the like. The instructions may comprise processor-specific instructions generated by a compiler and/or an interpreter from code written in any suitable computer-programming language, including, for example, C, C++, C#, Objective-C, PHP, Visual Basic, Java, Python, Perl, JavaScript, and ActionScript. An executable program may be stored in any portion or component of a memory device such as, for example, RAM, ROM, a hard drive, solid-state drive, USB flash drive, memory card, optical disc such as compact disc (“CD”) or digital versatile disc (“DVD”), floppy disk, magnetic tape, or other memory components.

The network 420 facilitates communication between the server 410 and at least one mobile device 450. The network 420 can include any suitable architecture for providing communication channels between the mobile device 450 and the server 410. A communication channel can include any suitable means capable of communicating signals between the mobile device 450 and the server 410. Non-limiting examples of the network 420 include any type of wired network, wireless network, or a combination of wired and wireless networks. A wireless network may be a WLAN, a wireless wide area network (“WIFI”), or any other type of wireless network now known or later developed. Additionally, the network 420 may be or include the Internet, intranets, extranets, microwave networks, satellite communications, cellular systems, personal communication services (“PCS”), infrared communications, global area networks, or other suitable networks, etc., or any combination of two or more such networks.

### General Considerations

The foregoing description of the aspects, including illustrated examples, has been presented only for the purpose of illustration and description and is not intended to be exhaustive or limiting to the precise forms disclosed. Many variations and modifications may be made to the above-described examples without departing substantially from the spirit and principles of the disclosure. All such modifications and variations are intended to be included herein within the scope of this disclosure and protected by the following claims.

The flowcharts described herein show certain functionality and operations performed by the management application, client application, proxy service and compliance service, respectively. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts described herein show a specific order of execution, it is understood that the order of execution may differ from that which is depicted. For example, the order of execution of two or more steps may be scrambled relative to the order shown. Also, two or more blocks shown in succession in the flow charts may be executed concurrently or with partial concurrence. Further, in some embodiments, one or more of the steps shown in the flow charts may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Any logic or application described herein that comprises software or code can be embodied in any non-transitory computer-readable medium for use by or in connection with a computing system such as, for example, a processor in a computer system or other system. In this sense, the logic may comprise, for example, statements including instructions and declarations that can be fetched from the computer-readable medium and executed by a computing system.

In the context of the present disclosure, a “computer-readable medium” can include any medium that can contain, store, maintain, or otherwise include the logic or application described herein for use by or in connection with a computing system. The computer-readable medium can comprise any one of many physical media such as, for example, magnetic, optical, or semiconductor media. More specific examples of a suitable computer-readable medium can include, but are not limited to, magnetic tapes, magnetic floppy diskettes, magnetic hard drives, memory cards, solid-state drives, USB flash drives, optical discs, etc. The computer readable medium may be a random access memory (“RAM”). Examples of a RAM can include (but are not limited to) static random access memory (“SRAM”), dynamic random access memory (“DRAM”), magnetic random access memory (“MRAM”), etc. The computer-readable medium may be a read-only memory (“ROM”), a programmable read-only memory (“PROM”), an erasable programmable read-only memory (“EPROM”), an electrically erasable programmable read-only memory (“EEPROM”), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and the following claims.

What is claimed is:

1. A system comprising:
a battery for powering a device;
a processing device; and
a memory device on which instructions are stored,
wherein the processing device is configured to execute the instructions and thereby:
track data about the battery;
determine a battery life of the battery based on the data, wherein the battery life indicates a degradation in the battery over multiple discharge cycles; and
notify a user of the device in response to determining that the battery life is below a threshold value.

2. The system of claim 1, wherein causing the processing device to track data about a battery comprises:
recording a manufacturing date of the battery; and
recording a number of discharge cycles or charge cycles performed by the battery.

3. The system of claim 2, wherein causing the processing device to determine the battery life of the battery based on the data comprises:
determining an expected depletion date based on the manufacturing date; and
determining an expected number of discharge cycles or an expected number of charge cycles.

4. The system of claim 1, wherein the battery is a first battery, wherein the data is first data, wherein the system further comprises one or more second batteries for powering additional devices, wherein further instructions are stored for causing the processing device to track second data about a battery life of the one or more second batteries, wherein causing the processing device to track first data about the first battery comprises recording a first time based on a duration for charging the first battery and a second time based on a duration for discharging the first battery.

5. The system of claim 4, wherein causing the processing device to determine the battery life of the battery based on the data comprises:
determining a model based on the second data; and
determining the battery life of the first battery based on comparing the first data to the model.

6. The system of claim 1, wherein causing the processing device to notify the user comprises determining the threshold value based on the time for the user to complete a task with the device.

7. The system of claim 6, wherein causing the processing device to notify the user comprises:
preventing the user from using the device with the battery; and
displaying a message to the user to replace the battery.

8. The system of claim 1, wherein the battery is a smart battery that includes the processing device and the memory.

9. A non-transitory computer-readable medium in which instructions executable by a processing device are stored, wherein executing the instructions causes the processing device to:
track data about a battery;
determine a battery life of the battery based on the data; and
notify a user of the device in response to determining that the battery life is below a threshold value.

10. The non-transitory computer-readable medium of claim 9, wherein causing the processing device to track data about a battery comprises:
recording a manufacturing date of the battery; and
recording a number of discharge cycles or charge cycles performed by the battery.

11. The non-transitory computer-readable medium of claim 10, wherein causing the processing device to determine the battery life of the battery based on the data comprises:
determining an expected depletion date based on the manufacturing date; and
determining an expected number of discharge cycles or an expected number of charge cycles.

12. The non-transitory computer-readable medium of claim 9, wherein the battery is a first battery, wherein the data is first data, wherein the instructions are further executable by the processing device for causing the processing device to track second data about a battery life of additional batteries, wherein causing the processing device to track first data about the first battery comprises recording a first time based on a duration for charging the first battery and a second time based on a duration for discharging the first battery.

13. The non-transitory computer-readable medium of claim 12, wherein causing the processing device to determine the battery life of the battery based on the data comprises:
determining a model based on the second data; and
determining the battery life of the first battery based on comparing the first data to the model.

14. The non-transitory computer-readable medium of claim 9, wherein causing the processing device to notify the user comprises determining the threshold value based on the time for the user to complete a task with the device.

15. The non-transitory computer-readable medium of claim 14, wherein causing the processing device to notify the user comprises:
preventing the user from using the device with the battery; and
displaying a message to the user to replace the battery.

16. A method performed by a computing system having one or more processing devices, the method comprising:
tracking data about the battery;
determining a battery life of the battery based on the data; and
notifying a user of the device in response to determining that the battery life is below a threshold value.

17. The method of claim 16, wherein tracking data about a battery comprises:
recording a manufacturing date of the battery; and
recording a number of discharge cycles or charge cycles performed by the battery.

18. The method of claim 17, wherein determining the battery life of the battery based on the data comprises:
determining an expected depletion date based on the manufacturing date; and
determining an expected number of discharge cycles or an expected number of charge cycles.

19. The method of claim 16, wherein the battery is a first battery, wherein the data is first data, the method further comprising:
tracking second data about a battery life of additional batteries,
determining a model based on the second data; and
determining the battery life of the first battery based on comparing the first data to the model.

20. The method of claim 19, wherein causing the processing device to notify the user comprises:
determining the threshold value based on the time for the user to complete a task with the device;
preventing the user from using the device with the battery; and
displaying a message to the user to replace the battery.
